(19) United States
(12) Patent Application Publication
(10) Pub. No.: US 2010/0182658 A1
(43) Pub. Date: Jul. 22, 2010

(54) IMAGE READING APPARATUS AND CONTROL METHOD FOR THE SAME, AND IMAGE FORMING APPARATUS INCLUDING THE SAME

(75) Inventor: Hae Chul KIM, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/686,582

(22) Filed: Jan. 13, 2010

(30) Foreign Application Priority Data
Jan. 20, 2009 (KR) 10-2009-4494

(51) Int. Cl. H04N 1/46

(52) U.S. Cl. 358/513

(57) ABSTRACT

An image reading apparatus, a method of controlling the same, and an image forming apparatus including the same are disclosed. The image reading apparatus may pre-recognize performances of even-pixel and odd-pixel groups for each color in an image sensor including an even-pixel group and an odd-pixel group for each color. In case of reading an image using only one of the above pixel groups, the image reading apparatus may read the image using a superior-performance pixel group selected from the above pixel groups, such that a signal-to-noise ratio (SNR) may be reduced and image processing may be more quickly carried out.

### CROSS-REFERENCE TO RELATED APPLICATIONS

This application claims priority under 35 U.S.C. §119(a) of Korean Patent Application No. 2009-0004494, filed on Jan. 20, 2009 in the Korean Intellectual Property Office, the disclosure of which is incorporated herein by reference.

### BACKGROUND

1. Field of the Invention

Embodiments of the present general inventive concept relate to an image reading apparatus including an image sensor composed of odd pixels and even pixels, a method of controlling the image reading apparatus, and an image forming apparatus including the image reading apparatus.

2. Description of the Related Art

Generally, an image reading apparatus included in an image forming apparatus, such as a copying machine, scans a document, receives a reflected light from the scanned document, and converts the reflected light into an analog image signal using an image sensor such as a charge coupled device (CCD) line sensor or the like. A variety of analog signal processes are applied to this analog image signal by an analog front end (AFE), such that the analog image signal is output as digital image data.

In recent times, an image sensor, which is divided into a group of even pixels (also called an even-pixel group) and a group of odd pixels (also called an odd-pixel group) for each color, has rapidly come into widespread use throughout the world so as to read a document at high speed.

However, there is a difference between characteristics of the above two groups, and a signal-to-noise ratio (SNR) is unavoidably deteriorated when an image is read using only a relatively inferior one of the two groups, resulting in a deterioration in image quality. For example, in the case where a performance of the even-pixel group is relatively lower than that of the odd-pixel group and the image reading apparatus reads an image at a resolution of 600 dpi, the image reading apparatus uses all the output signals generated from the odd-pixel group and the even-pixel group, such that there is no influence upon the image quality. Otherwise, if the image reading apparatus reads an image at 300 dpi, it uses only one of the two groups, resulting in a deterioration in image quality. For example, if the image reading apparatus reads an image using only the even-pixel group without using the odd-pixel group, image quality may be lower than another image quality acquired from both the even-pixel group and the odd-pixel group

### SUMMARY

Therefore, it is a feature of the present general inventive concept to provide an image reading apparatus which reads an image using a higher-performance group selected from an even-pixel group and an odd-pixel group for each color in an image sensor and thus improves image quality, a method of controlling the image reading apparatus, and an image forming apparatus including the same.

Additional features and utilities of the present general inventive concept will be set forth in part in the description which follows and, in part, will be obvious from the description, or may be learned by practice of the general inventive concept

Embodiments of the present general inventive concept include a method of controlling an image reading apparatus including an image sensor which is divided into an even-pixel group and an odd-pixel group for each of several colors includes determining a pixel group having superior pixel characteristics between an even-pixel group and an odd-pixel group for each color of the image sensor, and reading an image using the determined pixel group having the superior pixel characteristics between the even-pixel and odd-pixel groups for each color.

Embodiments of the present general inventive concept include a method of controlling an image reading apparatus including an image sensor which is divided into an even-pixel group and an odd-pixel group for each of several colors includes, upon receiving a power-supply signal, reading data of at least one of a white patch and a black patch using the image sensor, storing the read data classified according to individual colors of the image sensor, even-pixel groups and odd-pixel groups of the individual colors, comparing an average value of the even-pixel group for each color with an average value of the odd-pixel group for each color, determining a pixel group having a superior pixel performance between the even-pixel group and the odd-pixel group for each color, and storing the determined pixel group having the superior pixel performance for each color, and in case of reading the image using only one of the even-pixel group and the odd-pixel group of the image sensor, reading an image using the stored pixel group for each color.

Embodiments of the present general inventive concept include an image reading apparatus that includes an image sensor divided into an even-pixel group and an odd-pixel group for each of several colors, an analog front end (AFE) to convert analog data of the even-pixel group and analog data of the odd-pixel group for each color, generated from the image sensor, into digital data, a storage unit to store pixel values of an even-pixel group and an odd-pixel group for each color, wherein the pixel values are output from the analog front end (AFE), and a controller to determine a pixel group having a superior pixel performance between the even-pixel and odd-pixel groups for each color on a basis of average values of the even-pixel group and the odd-pixel group for each color.

Embodiments of the present general inventive concept include an image forming apparatus that includes an image sensor divided into an even-pixel group and an odd-pixel group for each of several colors, an analog front end (AFE) to convert analog image data of the even-pixel group and the odd-pixel group for each color, output from the image sensor, into digital image data, a storage unit to store the digital image data of the even-pixel group and the odd-pixel group for each color after the digital image data is output from the analog front end (AFE), a controller to determine a pixel group having a superior pixel performance between the even-pixel and odd-pixel groups for each color on a basis of the digital image data of the even-pixel group and the odd-pixel group for each color, and read an image using the determined pixel group, and a printer to print the image read by the controller.

Embodiments of the present general inventive concept further include a method of image sensing and forming, comprising producing an even-pixel group signal and an odd-pixel group signal for each color of a Red, Green, and Blue (RGB) analog signal, converting the even-pixel group signal and odd-pixel group signal for each color of the received RGB analog signal to a RGB digital image signal, determining which one of the even-pixel group signal or odd-pixel group signal for each RGB color has a superior pixel performance in comparison with stored RGB digital data; and forming an image according to the pixel group signal for each RGB color determined to have superior pixel performance.

Embodiments of the present general inventive concept further include an image reading apparatus, comprising an image sensor to output a Red, Green, and Blue (RGB) analog signal comprising an even-pixel group signal and an odd-pixel group signal for each RGB color, an analog front end (AFE) to receive the RGB analog signal and convert the RGB analog signal into a RGB digital signal, and a controller to receive and store the RGB digital signal from the AFE and determine a higher-performance pixel group among the even-pixel group and odd pixel group for each RGB color of the RGB analog signal.

### BRIEF DESCRIPTION OF THE DRAWINGS

These and/or other features and utilities of the present general inventive concept will become apparent and more readily appreciated from the following description of the exemplary embodiments, taken in conjunction with the accompanying drawings in which:

FIG. 1 is a schematic diagram illustrating an image reading apparatus according to an exemplary embodiment of the present general inventive concept;

FIG. 2 is a block diagram illustrating an image reading apparatus according to an exemplary embodiment of the present general inventive concept;

FIG. 3 is a structural diagram illustrating data stored in a storage unit of an image reading apparatus according to an exemplary embodiment of the present general inventive concept; and

FIG. 4 is a flow chart illustrating a method of deciding a higher-performance pixel group from among each color's even-pixel and odd-pixel groups reading a white patch of FIG. 3.

### DETAILED DESCRIPTION OF THE EXEMPLARY EMBODIMENTS

Reference will now be made in detail to the exemplary embodiments of the present general inventive concept, examples of which are illustrated in the accompanying drawings, wherein like reference numerals refer to like elements throughout.

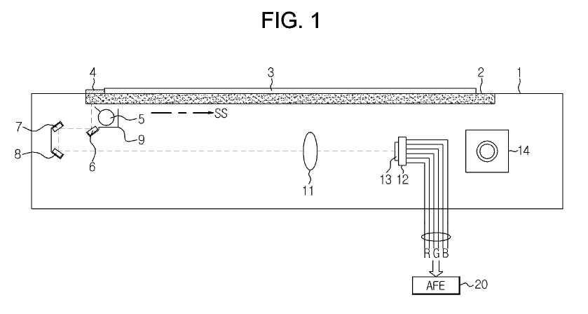

FIG. 1 is a schematic diagram illustrating an image reading apparatus according to an exemplary embodiment of the present general inventive concept.

Referring to FIG. 1, a contact glass 2 is located on the top of a main body 1 of the image reading apparatus. A document 3 to be read is placed on the contact glass 2. A press plate to bring a read page of the document 3 into contact with the contact glass 2 is generally placed on the back of the document, but the press plate is not illustrated in FIG. 1 for convenience of description. A white patch 4, which may construct a white reference image for shading correction, may be placed on the left of the contact glass 2.

A lamp 5 is used to illuminate a surface of the document 3. A reflected light from the document surface may sequentially reflect from a first mirror 6, a second mirror 7, and a third mirror 8, may focus on a lens 11, and may then illuminate on an image sensor located on a substrate 12.

The lamp 5 and the first mirror 6 may load on a first carriage 9, which moves back and forth in a sub-scanning direction (SS). The second mirror 7 and the third mirror 8 may load on a second carriage 10, which moves back and forth in the vertical scanning direction (VS).

In order to maintain the length of an optical path ranging from the contact glass 2 to the image sensor 13, the second carriage 10 may move at half (about ½) the speed of the first carriage 9.

The motor 14 may move the first carriage 9 and the second carriage 10.

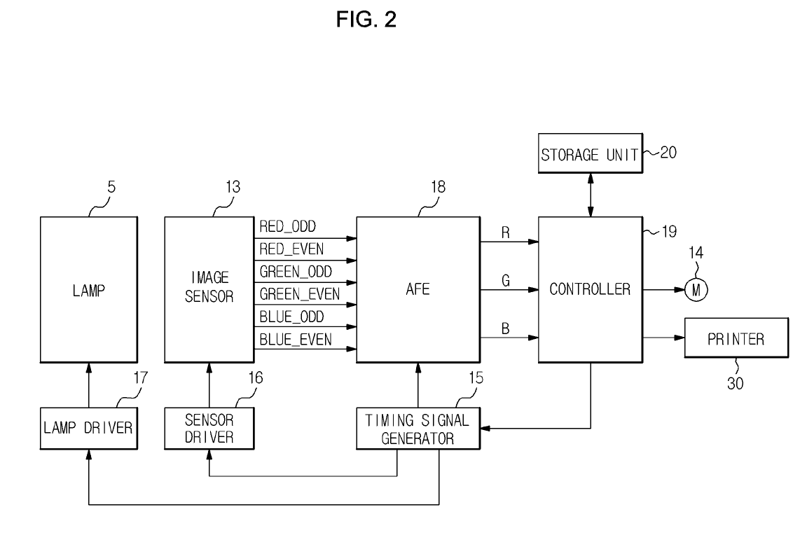

FIG. 2 is a block diagram illustrating an image reading apparatus according to an exemplary embodiment of the present general inventive concept.

Referring to FIG. 2, a timing signal generator 15 may output a variety of timing signals to a sensor driver 16 to drive an image sensor 13 and an analog front end (AFE) 18. The sensor driver 16 may output a synchronous signal and a clock signal to the image sensor 13.

The image sensor 13 may output a red/green/blue (RGB) analog signal by the sensor driver 16. The RGB analog signal may include an even-pixel group signal (RED_EVEN) and an odd-pixel group signal (RED_ODD) for red (R), an even-pixel group signal (GREEN_EVEN) and an odd-pixel group signal (GREEN_ODD) for green (G), and an even-pixel group signal (BLUE_EVEN) and an odd-pixel group signal (BLUE_ODD) for blue (B). The above-mentioned RGB analog signal may be usable with the AFE 18.

The AFE 18 may receive analog image signals of even- and odd-pixels for each of the RGB colors generated from the image sensor 13. The AFE 18 may perform a variety of signal processes including, for example, a sample/hold (S/H), black-level and/or white-level correction, signal amplification, analog-to-digital conversion (ADC) and the like, and may output a digital image signal of RGB colors. This RGB digital image signal may be usable with a controller 19.

The controller 19 controls overall operations of the image reading apparatus. The controller 19 may control the timing signal generator 15 to control the reading operation of the document using the image sensor 13, and at the same time may control a lamp driver 17 to drive the lamp 5 to read the document using the image sensor 13.

The controller 19 drives the motor 14 to move the first carriage 9 and the second carriage 10.

For example, if the image reading apparatus is powered on or a current time reaches a predetermined test time, the controller 19 may drive the motor 14 such that it moves the first carriage 9 and the second carriage 10 toward the white patch 4. If the first carriage 9 reaches the vicinity of the white patch 4, the lamp 5 may switch on by the lamp driver 17, and the sensor driver 16 may operate by the timing signal generator 15, so that the image sensor 13 reads the white patch 4 serving as a white collimation sheet. Therefore, the RGB analog signal, generated when the white patch 4 is read on the condition that the lamp 5 is switched on, may be generated from the image sensor 13. This RGB analog signal may include an even-pixel group signal (RED_EVEN) and an odd-pixel group signal (RED_ODD) for red (R), an even-pixel group signal (GREEN_EVEN) and an odd-pixel group signal (GREEN_ODD) for green (G), and an even-pixel group signal (BLUE_EVEN) and an odd-pixel group signal (BLUE_ODD) for blue (B).

The RGB analog signal generated from the image sensor 13 may convert into an RGB digital signal via the AFE 18, and the RGB digital signal is usable with the controller 19. The controller 19 may store the RGB digital signal in the storage unit 20.

Thereafter, the controller 19 may control the lamp driver to turn off the lamp 5, and drive the sensor driver 16 via the timing signal generator 15, such that it controls the image sensor 13 to read the white patch 4 serving as the white collimation sheet 4. Therefore, the RGB analog signal, generated when the white patch is read on the condition that the lamp 5 is switched off, may be generated from the image sensor 13. This RGB analog signal includes an even-pixel group signal (RED_EVEN) and an odd-pixel group signal (RED_ODD) for red (R), an even-pixel group signal (GREEN_EVEN) and an odd-pixel group signal (GREEN_ODD) for green (G), and an even-pixel group signal (BLUE_EVEN) and an odd-pixel group signal (BLUE_ODD) for blue (B).

The RGB analog signal generated from the image sensor 13 may convert into an RGB digital signal via the AFE 18, and the RGB digital signal may be usable with the controller 19. The controller 19 may store the RGB digital signal in the storage unit 20.

A printer 30 may print the image read by a control signal of the controller 19 on a recording medium, and the recording medium including the image may discharge to the outside.

The controller 19 may decide a higher-performance pixel group from among an even-pixel group and an odd-pixel group for each color on the basis of an average value of digital image data of the even-pixel and odd-pixel groups. In case of reading the image, the controller 19 may read the image using the decided higher-performance pixel group for each color, and the read image may print on the recording medium by the printer 30.

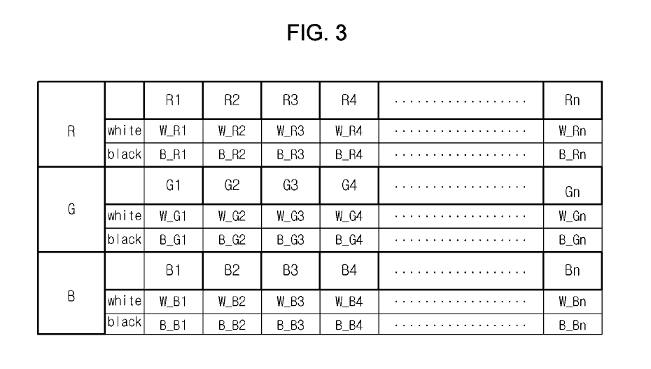

FIG. 3 shows RGB digital data stored in the storage unit of the image reading apparatus according to an exemplary embodiment of the present general inventive concept.

Referring to FIG. 3, RGB digital data generated when the white patch is read on the condition that the lamp is switched on, may constitute (W_R1, W_R2, . . . , W_Rn), (W_G1, W_G2, . . . , W_Gn), and (W B1, W_B2, . . . , W_Bn). Also, RGB digital data (i.e., RGB digital data generated when a black patch is read) generated when the white patch is read on the condition that the lamp is switched off, may constitute (B_R1, B_R2, . . . , B_Rn), (B_G1, B_G2, . . . , B_Gn), and (B_B1, B_B2, . . . , B_Bn). That is, the RGB digital signal, generated when the white patch is read on the condition that the lamp is switched on, may represent that the white patch is read. The other RGB digital data, generated when the white patch is read on the condition that the lamp is switched off, may represent that the black patch is read.

The controller 19 of the image reading apparatus may decide which one of an even-pixel group and an odd-pixel group for each RGB color has a relatively-superior pixel performance using the RGB digital data stored in the storage unit 20, and may store the decided pixel group. Under this condition, if there is a need for the controller 19 to read an image using only one of the two pixel groups, the controller 19 may read a document using the decided pixel group having the relatively superior pixel performance.

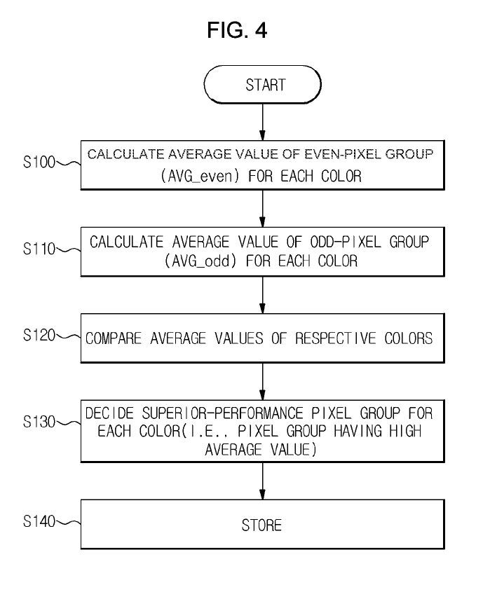

A method to decide a higher-performance group between each color's even-pixel and odd-pixel groups acquired by reading the white patch will hereinafter be described with reference to FIG. 4. The controller 19 may calculate an average value of even-pixel group data generated by reading the white patch for each RGB color in the RGB digital data stored in the storage unit 20 at operation S100, and then may calculate an average value of odd-pixel group data for each RGB color at operation S110. For example, in case of red (R), the even-pixel group data generated when the white patch is read constitutes W_R2, W_R4, . . . , W_Rn-1, and the odd-pixel group data generated when the white patch is read constitutes W_R1, W_R3, . . . , W_Rn-1. Therefore, the controller 19 may calculate an average value of each pixel group data.

After calculating an average value of the even-pixel group data generated by reading the white patch for each color and the other average value of the odd-pixel group data at operations S100 and S110, respectively, the controller 19 may compare the two average values of the even-pixel and odd-pixel group data with each other at operation S120, such that the controller 19 may decide which one of the pixel groups has a higher average value. The controller 19 may determine that the decided pixel group having a higher average value has a superior-performance pixel group at operation S130. In this case, if a difference between the average value of the even-pixel group data and the other average value of the odd-pixel group data is in a predetermined range, the controller 19 may calculate a standard deviation of the difference, and may determine that one pixel group having a relatively-low standard deviation is a pixel group having a superior performance. The controller 19 may determine whether the decided pixel group having the superior performance is the even-pixel group or the odd-pixel group, and may store the determined result in the storage unit 20 at operation S140. If the image reading apparatus needs to read the image using only one of the even-pixel and odd-pixel groups, the image reading apparatus may read a document using one pixel group having the superior performance.

In another exemplary embodiment of the present general inventive concept, the controller 19 may calculate an average value of even-pixel group data generated by reading the white patch for each RGB color in RGB digital data stored in the storage unit 20, and may calculate an average value of odd-pixel group data for each color of the RGB colors. For example, in case of red (R), the even-pixel group data generated when the black patch is read constitutes B_R2, B_R4, . . . , B_Rn-1, and the odd-pixel group data generated when the black patch is read constitutes B_R1, B_R3, . . . , B_Rn-1. Therefore, the controller 19 may calculate an average value of each pixel group data.

After calculating an average value of the even-pixel group data generated by reading the black patch for each color and the other average value of the odd-pixel group data, the controller 19 may compare the two average values of the even-pixel and odd-pixel group data with each other, such that the controller 19 may decide which one of the pixel groups has a smaller average value. The controller 19 may determine that the decided pixel group having a higher average value has a superior-performance pixel group at operation S130. In this case, if a difference between the average value of the even-pixel group data and the other average value of the odd-pixel group data is in a predetermined range, the controller 19 may calculate a standard deviation of the difference, and may determine that one pixel group having a relatively-low standard deviation is a pixel group having a superior performance. If the image reading apparatus needs to read a document image using only one of the even-pixel and odd-pixel groups, the image reading apparatus reads the document using one pixel group having the superior performance.

On the other hand, in another example, the controller 19 may calculate an average value of the even-pixel group data generated by reading the black and white patches and the other average value of the odd-pixel group data, the controller 19 may compare the two average values of the even-pixel and odd-pixel group data with each other, and may decide which one of the pixel groups has a superior pixel performance. That is, the controller 19 may determine which one of even-pixel group data and odd-pixel group data acquired when the white patch is read has a higher average value, and may decide that the determined pixel group has a higher pixel performance. The controller 19 may determine which one of even-pixel group data and odd-pixel group data acquired when the black patch is read has a smaller average value, and may decide that the determined pixel group has a higher pixel performance.

As is apparent from the above description, the image reading apparatus may pre-recognize performances of even-pixel and odd-pixel groups for each color in an image sensor including an even-pixel group and an odd-pixel group for each color. If there is a need to read an image using only one of the above pixel groups, the image reading apparatus may read the image using a superior-performance pixel group selected from the above pixel groups, such that a signal-to-noise ratio (SNR) is reduced and image processing is more quickly carried out.

Although a few exemplary embodiments of the present general inventive concept have been illustrated and described, it would be appreciated by those skilled in the art that changes may be made in these embodiments without departing from the principles and spirit of the general inventive concept, the scope of which is defined in the claims and their equivalents.

What is claimed is:

1. A method of controlling an image reading apparatus including an image sensor which is divided into an even-pixel group and an odd-pixel group for each of several colors, the method comprising:
determining a pixel group having superior pixel characteristics between an even-pixel group and an odd-pixel group for each color of the image sensor; and
reading an image using the determined pixel group having the superior pixel characteristics between the even-pixel and odd-pixel groups for each color.

2. The method according to claim 1, wherein the determining of the pixel group having the superior pixel characteristics includes:
reading data of at least one of a white patch and a black patch by the image sensor;
storing the read data classified according to individual colors of the image sensor, even-pixel groups, and odd-pixel groups of the individual colors;
comparing an average value of the even-pixel group for each color with an average value of the odd-pixel group for each color; and
determining a pixel group having a superior pixel performance between the even-pixel group and the odd-pixel group for each color.

3. The method according to claim 2, wherein, when reading only the white patch, a pixel group having a higher average value, between the average value of the even-pixel group reading the white patch and another average value of the odd-pixel group reading the white patch, is decided as a superior pixel group having a superior pixel performance.

4. The method according to claim 3, wherein, a pixel group having a smaller standard deviation, between a standard deviation of the even-pixel group reading the white patch and another standard deviation of the odd-pixel group reading the white patch, is decided as a superior pixel group having a superior pixel performance.

5. The method according to claim 2, wherein, when reading only the black patch, a pixel group having a smaller average value, between an average value of the even-pixel group reading the black patch and another average value of the odd-pixel group reading the black patch, is decided as a superior pixel group having a superior pixel performance.

6. The method according to claim 5, wherein, a pixel group having a smaller standard deviation, between a standard deviation of the even-pixel group reading the black patch and another standard deviation of the odd-pixel group reading the black patch, is decided as a superior pixel group having a superior pixel performance.

7. The method according to claim 1, further comprising:
when reading a white patch and a black patch, determining which one of the even-pixel group reading the white patch and the odd-pixel group reading the white patch has a higher average value, determining which one of the even-pixel group reading the black patch and the odd-pixel group reading the black patch has a smaller average value, and deciding each of the determined pixel groups to be a superior pixel group having a superior pixel performance.

8. The method according to claim 1, further comprising:
when reading the image using only one of the even-pixel group and the odd-pixel group of the image sensor, determining a pixel group having a superior pixel performance between the even-pixel group and the odd-pixel group for each color of the image sensor.

9. A method of controlling an image reading apparatus including an image sensor which is divided into an even-pixel group and an odd-pixel group for each of several colors comprising:
upon receiving a power-supply signal, reading data of at least one of a white patch and a black patch by the image sensor;
storing the read data classified according to individual colors of the image sensor, even-pixel groups, and odd-pixel groups of the individual colors;
comparing an average value of the even-pixel group for each color with an average value of the odd-pixel group for each color;
determining a pixel group having a superior pixel performance between the even-pixel group and the odd-pixel group for each color; and
storing the determined pixel group having the superior pixel performance for each color; and
in case of reading the image using only one of the even-pixel group and the odd-pixel group of the image sensor, reading an image using the stored pixel group for each color.

10. An image reading apparatus comprising:
an image sensor divided into an even-pixel group and an odd-pixel group for each of several colors;
an analog front end (AFE) to convert analog data of the even-pixel group and analog data of the odd-pixel group for each color, generated from the image sensor, into digital data;
a storage unit to store pixel values of an even-pixel group and an odd-pixel group for each color, wherein the pixel values are output from the analog front end (AFE); and
a controller to determine a pixel group having a superior pixel performance between the even-pixel and odd-pixel groups for each color on a basis of average values of the even-pixel group and the odd-pixel group for each color.

11. The apparatus according to claim 10, wherein the pixel values, stored in the storage unit, of the even-pixel group and the odd-pixel group for each color are acquired when at least one of a white patch and a black patch is read.

12. The apparatus according to claim 11, wherein the controller determines which one of the even-pixel group reading the white patch and the odd-pixel group reading the white patch has a higher average value, and decides the determined pixel group having the higher average value to be a superior pixel group having a superior pixel performance.

13. The apparatus according to claim 12, wherein the controller determines which one of the even-pixel group and the odd-pixel group has a smaller standard deviation, and decides the determined pixel group having the smaller standard deviation to be a superior pixel group having a superior pixel performance.

14. The apparatus according to claim 11, wherein the controller determines which one of the even-pixel group reading the black patch and the odd-pixel group reading the black patch has a smaller average value, and decides the determined pixel group having the smaller average value to be a superior pixel group having a superior pixel performance.

15. The apparatus according to claim 14, wherein the controller determines which one of the even-pixel group and the odd-pixel group has a smaller standard deviation, and decides the determined pixel group having the smaller standard deviation to be a superior pixel group having a superior pixel performance.

16. The apparatus according to claim 11, wherein the controller determines which one of the even-pixel group reading the white patch and the odd-pixel group reading the white patch has a higher average value, determines which one of the even-pixel group reading the black patch and the odd-pixel group reading the black patch has a smaller average value, and decides which of the determined pixel groups to be a superior pixel group having a superior pixel performance.

17. The apparatus according to claim 10, wherein the controller, in case of reading an image using only one of the even-pixel group and the odd-pixel group of the image sensor, reads the image using the determined pixel groups each having the superior pixel performance.

18. The apparatus according to claim 10, wherein the controller, when reading the image using only one of the even-pixel group and the odd-pixel group of the image sensor, determines a pixel group having a superior pixel performance between the even-pixel group and the odd-pixel group for each color of the image sensor.

19. An image forming apparatus comprising:
an image sensor divided into an even-pixel group and an odd-pixel group for each of several colors;
an analog front end (AFE) to convert analog image data of the even-pixel group and the odd-pixel group for each color output from the image sensor into digital image data;
a storage unit to store the digital image data of the even-pixel group and the odd-pixel group for each color after the digital image data is output from the analog front end (AFE);
a controller to determine a pixel group having a superior pixel performance between the even-pixel and odd-pixel groups for each color on a basis of the digital image data of the even-pixel group and the odd-pixel group for each color, and to read an image using the determined pixel group; and
a printer to print the image read by the controller.

20) A method of image sensing and forming, comprising:
producing an even-pixel group signal and an odd-pixel group signal for each color of a Red, Green, and Blue (RGB) analog signal;
converting the even-pixel group signal and odd-pixel group signal for each color of the received RGB analog signal to a RGB digital image signal;
determining which one of the even-pixel group signal or odd-pixel group signal for each RGB color has a superior pixel performance in comparison with stored RGB digital data; and
forming an image according to the pixel group signal for each RGB color determined to have superior pixel performance.

21) The method of claim 20, wherein forming the image includes reading a control signal transmitted from a controller.

22) The method of claim 20, wherein the RGB signal is transmitted from an image sensor.

23) The method of claim 20, wherein the analog front end processes comprise:
at least one of a sample/hold (S/H), black-level and/or white-level correction, signal amplification, and analog-to-digital conversion (ADC).

24) An image reading apparatus, comprising:
an image sensor to output a Red, Green, and Blue (RGB) analog signal comprising an even-pixel group signal and an odd-pixel group signal for each RGB color;
an analog front end (AFE) to receive the RGB analog signal and convert the RGB analog signal into a RGB digital signal; and
a controller to receive and store the RGB digital signal from the AFE and determine a higher-performance pixel group among the even-pixel group and odd pixel group for each RGB color of the RGB analog signal.

25) The image reading apparatus of claim 24, wherein the RGB color signal generated by the image sensor comprises of reading a white patch when a lamp of the image reading apparatus is switch on.

26) The image reading apparatus of claim 25, wherein the white patch functions as a white base reference for shading correction.

27) The image reading apparatus of claim 24, wherein the higher-performance pixel group is determined based a comparison between an average value for each color within the even-pixel group signal and an average value for each color within the odd-pixel group signal.
